(19) United States
(12) Patent Application Publication
(10) Pub. No.: US 2008/0097003 A1
(43) Pub. Date: Apr. 24, 2008

(54) Process for Preparation of Food Packaging Film Containing Chitosan

(76) Inventor: Jung Ho Han, Busan (KR)

Correspondence Address: PARK LAW FIRM, 3255 WILSHIRE BLVD, SUITE 1110, LOS ANGELES, CA, 90010, US

(21) Appl. No.: 11/576,669

(22) PCT Filed: Sep. 30, 2005
(86) PCT No.: PCT/KR05/03242

§ 371 Date: Apr. 4, 2007

(30) Foreign Application Priority Data
Oct. 7, 2004 (KR) 10-2004-0080078

(51) Int. Cl. C08L 23/06

(52) U.S. Cl. 523/122

(57) ABSTRACT

Disclosed herein is a method for preparing a food packaging film containing chitosan comprising 90.0 to 98.0% by weight of polyethylene resin and 2.0 to 10.0% by weight of a premix containing chitosan, in which the premix comprises fine flakes of polyethylene film and chitosan powder in a ratio of 80.0 to 99.5% by weight: 0.5 to 20.0% by weight. According to the method, in order to evenly disperse and distribute chitosan in the food packaging film, chitosan powder is previously mixed with synthetic resin film flakes to prepare a premix. The premix is mixed with a synthetic resin in a predetermined ratio and extruded to prepare the food packaging film. As a result, it is possible to industrially mass-produce the food packaging film, which has chitosan powder particles evenly dispersed and distributed therein and maintain excellent elongation and tensile strength.

### TECHNICAL FIELD

The present invention relates to a method for preparing a food packaging film containing chitosan, and more particularly, it relates to a method for preparing a food packaging film using a premix containing chitosan powder, in which the chitosan powder particles are evenly dispersed and distributed in the food packaging film so that they can be slowly released to prevent deterioration of the food by microorganisms upon a long term storage, while suppressing oxidation and maintaining peculiar taste and color of the food for fresh storage.

### BACKGROUND ART

Generally, it is the most important in the food industry to extend the storage time of food. Up to now, artificially synthesized additives of preservatives have been added to food directly or indirectly to improve the storage stability of food. However, such additives which is harmful to human bodies may exert a bad influence to health as well as peculiar flavor and fragrance of foods. Therefore, there is an urgent need for a method of extending food storage time without using such a preservative.

In order to overcome the foregoing problems, research for developing antibacterial packaging film is being actively conducted. It is general that the antibacterial packaging film provides antibacterial property to the packaging material according to types of added antibacterial substances and preparation methods. Particularly, the antibacterial effect, maintenance and properties of the packaging material can vary depending on interaction between the used antibacterial substance and high molecules, which is the main component of the film construction.

Components used for preparing the antibacterial film are roughly divided into two: one is a high molecule having antibacterial activity and the other is a high molecule serving as a structure or a carrier needed to receive a foreign antibacterial substance. A representative example of the high molecule having antibacterial activity is chitosan, biopolymer. Chitosan is a sort of natural polysaccharide widely existing in the nature and has antibacterial effect, heavy metal adsorption effect, antioxidation effect and film formability. Also, it is a functional substance showing various functions that a food packaging film needs, such as stabilization of blood pressure, enhancement of immunity, ability of adsorption and excretion of fat and cholesterol, water retention ability and anti-tumor effect and thus, is suitable as a material for a food packaging film. The mechanism of antibacterial activity of chitosan is that the amino group of chitosan having a positive charge works on the cell wall to change permeability, whereby cytoplasma flows out, leading extinction of the cell. Chitosan shows stronger antibacterial activity when it is degraded into a suitable size having a small molecular weight, as compared to the high molecular weight molecule

Therefore, many researches on a food packaging film using chitosan have been conducted and are filed as patents. For example, Korean Registered Patent No. 10-0357845 (2002 Oct. 9) discloses a method for preparing a biodegradable film comprising a complex of chitosan and starch. The method includes dispersing starch in acetic acid aqueous solution to prepare a starch dispersion, dissolving chitosan and polyvinyl alcohol (PVA) in acetic acid aqueous solution, mixing the chitosan/PVA solution and the starch dispersion and forming the mixture into a film on a glass plate. However, this method has problems in that the produced film has non-uniform thickness and the preparation cannot be performed as a continuous process, which is not applicable to industrial production. Also, since chitosan contained in the film is not evenly dispersed, the film cannot show uniform antibacterial activity throughout the film surface.

Also, Korean Patent Publication No. 39219 (2004 May 10) discloses a method for preparing a complex plastic film structure having antibacterial effect by coating a mixture of a biopolymer, a plasticizer and an antibacterial substance on a conventional synthetic resin polymer film into a thin layer to form a multi-layered film structure. However, the chitosan thin layer shows poor elongation and tensile strength while the conventional synthetic resin polymer film shows good elongation and tensile strength. Thus, the difference between physical properties of the two materials may cause breakage of film or layer separation between the two materials, that is, deterioration in film performance. Also, when chitosan is completely dissolved in an organic acid solvent, it becomes insoluble. As a result, when the film is used to package a water containing food, chitosan cannot be released and fails to show antibacterial activity. In addition, this technology has problems of a complicated process for thin layer coating.

Also, when the added amount of the antibacterial substance is increased to enhance the antibacterial effect of the food packaging film, bonding between the chains of the carrier high molecules. As a result, elongation of the produced antibacterial film is reduced, causing reduction in mechanical properties of the film such as tensile strength. At present, in development of a food packaging film using chitosan, there are technical problems such as affinity to conventional materials, transparency, film properties and the like which are necessary in preparing film, since solubility of chitosan is greatly affected by pH, solvent, temperature and the like.

### DISCLOSURE OF INVENTION

### Technical Problem

Accordingly, the present invention has been made to solve the above-mentioned problems occurring in the prior art, and it is an object of the present invention to provide a method for preparing a food packaging film containing chitosan, in which the chitosan powder particles are evenly dispersed and distributed in the food packaging film so that they can be slowly released to prevent deterioration of food by microorganisms upon storage of food, while maintaining water content and taste for fresh storage of foods.

Also, it is another object of the present invention to provide a method for preparing a food packaging film containing chitosan comprising well-mixing fine flakes of a synthetic resin film and chitosan powder mixing the premix with a synthetic resin and extruding the mixture according to a conventional film making method to form the food packaging film, in which chitosan powder is evenly dispersed and distributed in the prepared food packaging film using a premix. Therefore, it is possible to industrially mass-produce a film with chitosan powder dispersed and distributed therein and the produced film maintains excellent film properties such as stretch force and tensile strength.

### Technical Solution

To accomplish the above objects, according to the present invention, there is provided a food packaging film containing chitosan prepared by mixing 90.0 to 98.0% by weight of polyethylene resin and 2.0 to 10.0% by weight of a premix containing chitosan, in which the premix comprises fine flakes of polyethylene film and chitosan powder in a ratio of 80.0 to 99.5% by weight: 0.5 to 20.0% by weight.

In addition to polyethylene (PE), synthetic resins which can be used in the present invention include polypropylene (PP), polyamide (PA), polycarbonate (PC), polyvinyl chloride (PVC), polystylene (PS), polyethylene terephthalate (PET), ethylene vinyl acetate (EVA) and the like which can be used alone or in combination.

If the polyethylene resin content exceeds 98.0% by weight or the premix content is less than 2.0% by weight, the antibacterial effect of the food packaging film is deteriorated since the chitosan powder content is relatively small, as compared to the polyethylene resin content. If the polyethylene resin content is less than 90.0% by weight or the premix content exceeds 10.0% by weight, the antibacterial effect of the food packaging film is improved but bonding force between the polyethylene resin chains is reduced due to the increase of the chitosan powder content. As a result, the elongation of the final food packaging film is poor, leading reduction of tensile strength, which is one of important mechanical properties, and thereby, deterioration in economical competitive power.

Also, in the premix containing chitosan, if the content of the polyethylene film flakes exceeds 99.5% by weight or the chitosan powder content is less than 0.5% by weight, the antibacterial effect of the food packaging film is decreased since the chitosan powder content is relatively small, as compared to the polyethylene resin content. If the content of the polyethylene film flakes is less than 80.0% by weight or the chitosan powder content exceeds 20.0% by weight, the antibacterial effect of the food packaging film is improved but bonding force between chains of the polyethylene resin is reduced due to the increase of the chitosan powder content. As a result, the elongation of the final food packaging film is poor, leading reduction of tensile strength, which is one of important mechanical properties, and thereby, deterioration in economy competitive power.

The present invention comprises a method for evenly dispersing and distributing chitosan powder particles in a food packaging film, in which previously prepared synthetic resin film flakes is mixed with chitosan powder particles to form a premix. Since the previously prepared premix is mixed with a synthetic resin in a pre-determined ratio and extruded according to a common film making method to form a food packaging film, it is possible to industrially mass-produce the food packaging film having the chitosan powder particles evenly dispersed and distributed therein and the film maintains excellent elongation and tensile strength.

The flakes of the polyethylene film used in the premix are prepared by cutting a polyethylene film having a thickness of 5 to 70 [symbol] into a size of 0.5 to 5 [symbol] so that the chitosan particles can be thoroughly mixed with the synthetic resin material and be uniformly dispersed in the produced food packaging film. Here, the flakes of the polyethylene film in the premix may generate static electricity, due to friction between flakes upon mixing. By such static electricity, the chitosan powder particles are attached to the flakes of the polyethylene film and thus, can be evenly dispersed together with the polyethylene film upon mixing with the synthetic resin.

When the chitosan powder has a molecular weight of 30,000 to 500,000, it may be added to an organic acid solution to a pH of 3.0 to 6.0 to prepare a chitosan solution, which is then lyophilized for 24 to 72 hours to form powder. Meanwhile, when the chitosan powder has a low molecular weight of less than 30,000 and is an oligosaccharide, it can be used as it is without dissolution in an organic acid since it is water-soluble and is readily released upon packaging to show antibacterial effect.

If the solution of the chitosan powder is strong acid with a pH of less than 3.0, the produced food packaging film causes deterioration of peculiar taste and color of food. If over a pH of 6.0, the solubility is considerably reduced to produce a colloidal solution which cannot show antibacterial activity.

The chitosan powder has a particle size of 4 to 50 [symbol] . If the size is less than 4 [symbol] , a large amount of chitosan is buried in the film and its exposed part on the film surface is small, causing reduction in release and thereby, antibacterial activity. If the size exceeds 50 [symbol] , the film has a bonding force reduced, causing reduction in mechanical properties such as tensile strength and elongation.

Here, usable organic acids include acetic acid, citric acid, lactic acid, sorbic acid, benzoic acid, ascorbic acid, succinic acid and the like, which may be used alone or in combination.

According to the present invention, the food packaging film containing chitosan is prepared by a process comprising the steps of:

[symbol] ) adding chitosan powder having a molecular weight of 30,000 to 500,000 to an organic acid solution to a pH of 3.0 to 6.0 to form a chitosan solution and lyophilizing the solution for 24 to 72 hours, followed by pulverization to form fine powder particles;

[symbol] ) mixing 80.0 to 99.5% by weight of fine flakes of polyethylene film, separately prepared, with 0.5 to 20.0% by weight of the chitosan powder, prepared in the step [symbol] ) to form a premix containing chitosan; and

[symbol] ) extruding 2.0 to 10.0% by weight of the premix containing chitosan, prepared in the step ii), with 90.0 to 98.0% by weight of polyethylene resin.

Here, when a low molecular weight molecule having a molecular weight of less than 30,000 and a oligosaccharide is used as the chitosan powder in the step [symbol] ), the chitosan powder can be used as it is without dissolution in an organic acid.

Also, in the step iii), an extruder is set to have a temperature polio of 100 to 120° C. at an inlet, 160 to 180° C. at an kneading zone and 150 to 170° C. at an extrusion zone to prevent carbonization of the chitosan powder with the synthetic resin.

### ADVANTAGEOUS EFFECTS

According to the present invention, the food packaging film is prepared by mixing a synthetic resin material with a premix comprising flakes of polyethylene film and chitosan powder so that the chitosan powder particles can be uniformly dispersed and distribute in the food packaging film. Therefore, the preparation process is simple and the chitosan powder distributed in the food packaging film can be slowly released over time, while maintaining water holding capacity and peculiar taste of food, and elongation and tensile strength of the film. Also, the film has excellent antibacterial effect to prevent deterioration of food by propagation of microorganisms and is suitable for fresh storage of food.

### DESCRIPTION OF DRAWINGS

Further objects and advantages of the invention can be more fully understood from the following detailed description taken in conjunction with the accompanying drawings in which:

FIG. 1 is a graph showing the change in pH over time when the food packaging film according to the present invention is used;

FIG. 2 is a graph showing the change in the amount of volatile basic nitrogen over time when the food packaging film according to the present invention is used;

FIG. 3 is a graph showing the change in the number of live bacteria over time when the food packaging film according to the present invention is used;

FIG. 4 is a graph showing the change in water holding capacity over time when the food packaging film according to the present invention is used;

FIG. 5 is a graph showing the change in water content over time when the food packaging film according to the present invention is used;

FIG. 6 is a graph showing the change in shear force over time when the food packaging film according to the present invention is used;

FIG. 7 is a graph showing the change in lipid oxidation over time when the food packaging film according to the present invention is used;

FIG. 8 is a SEM photograph showing a conventional packaging film;

FIG. 9 is a SEM photograph showing the packaging film according to the present invention; and

FIG. 10 is a SEM photograph showing the condition after chitosan has been removed from the packaging film of FIG. 9.

### BEST MODE

Now, the present invention will be described hereinafter in detail with reference to the attached drawings.

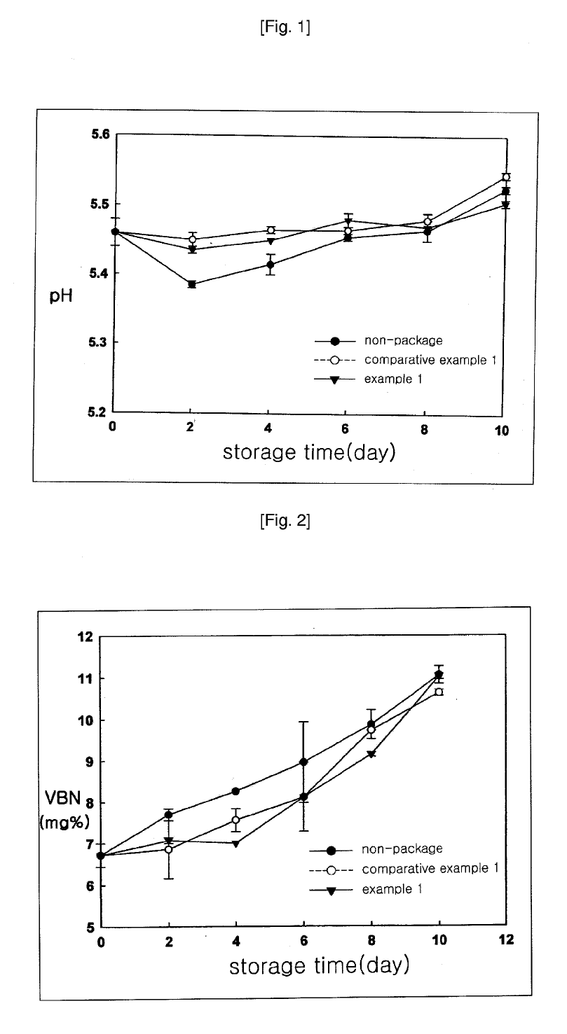

FIGS. 1 to 7 show changes in pH, amount of volatile basic nitrogen, number of live bacteria, water holding capacity, water content, meat quality and lipid oxidation of meat over time when the packaging film according to the present invention is used for packaging meat.

The meat used in the experiment was pork sirloin of one pig provided from a slaughterhouse on the slaughter day. The meat was cut under the same condition and classified into a non-packaged group, a group packed in a conventional film, a group packed in Comparative Example 1 and a group packed in Example 1, which is the chitosan containing film according to the present invention. Each package was stored in a refrigerator at 4° C. and examined for the amount of volatile basic nitrogen, the number of live bacteria, the water holding capacity in meat, the meat tenderness, the water content of meat, oxidation of lipid, fat component of meat and pH of meat and the results were compared. The reason why the pork sirloin is used is that this part comprises muscle and lipid in the same amount, as compared to other parts of pork. Also, the sirloin was provided from one pig to obtain a sample under the same condition.

FIG. 1 is a graph showing the change in pH over time when the food packaging film according to the present invention is used. In case of non-package, the pork sirloin showed severe pH change as the storage time increased. Comparative Example 1 using a common food packaging film showed a little pH change until the 8^{th} day but abrupt change after then, unlike Example 1.

FIG. 2 is a graph showing the change in the amount of volatile basic nitrogen (VBN) over time when the food packaging film according to the present invention is used. In case of non-package, sever denaturation of protein which was a main component of the meat was observed and the amount of volatile basic nitrogen was gradually increased. Both Example 1 and Comparative Example 1 showed similar amounts of volatile basic nitrogen by the early second day. However, during the 4th to 8^{th} day, Example 1 showed less volatile basic nitrogen, as compared to Comparative Example 1, by antibacterial effect and denaturation inhibiting effect and it was thus noted that the sample was stably stored.

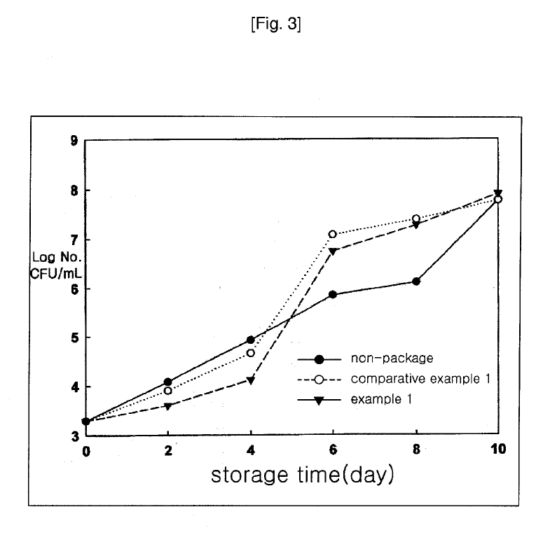

FIG. 3 is a graph showing the change in the number of live bacteria over time when the food packaging film according to the present invention is used. The experiment examining decomposition of the sample meat by microorganisms was performed by measuring the number of live bacteria (Log No. CFU/mL). From the result, it was noted that Example 1 showed less live bacteria than that of Comparative Example 1 during the 2^{nd} to 6^{th} day. In case of non-package, the number of living bacteria increased until the 4^{th} day, showing the maximum at that day but decreased from then to be less than those of Example 1 and Comparative Example 1. It is believed that this was because the growth of microorganisms was suppressed since the sample is dried off due to moisture loss due to non-package.

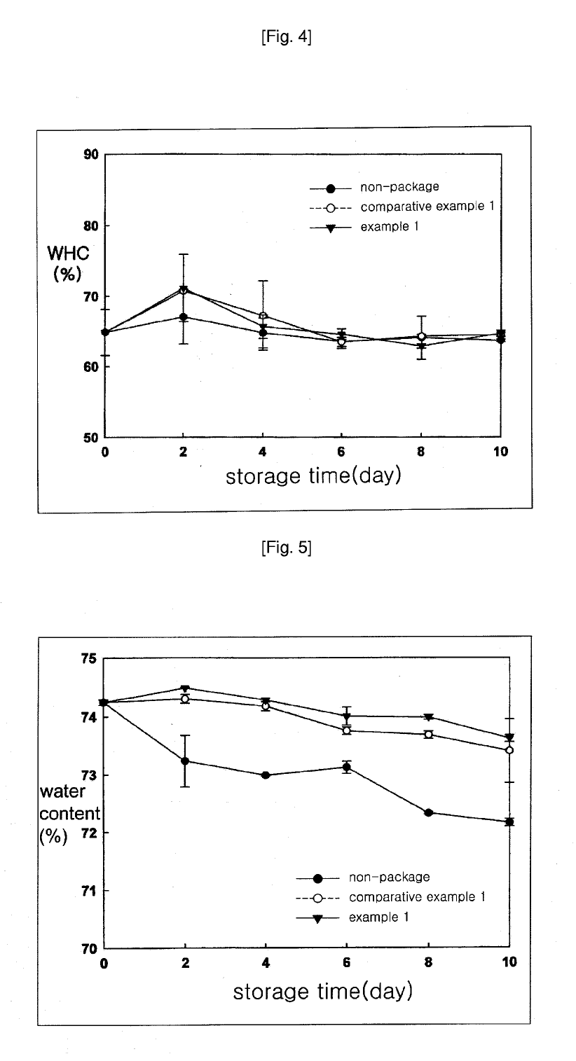

FIG. 4 and FIG. 5 are graphs showing the change in water holding capacity (WHC) and water content over time, respectively, when the food packaging film according to the present invention is used. For water holding capacity, the sample using the common packaging film of Comparative Example 1 showed a similar level to that of sample of Example 1. The non-packaging sample showed dramatic reduction of water content after 2 days while the Comparative Example 1 sample and the Example 1 sample showed high water contents even after 6 days. Particularly, the Example 1 sample showed the highest water content, and thus it was proved that the packaging film according to the present invention was excellent.

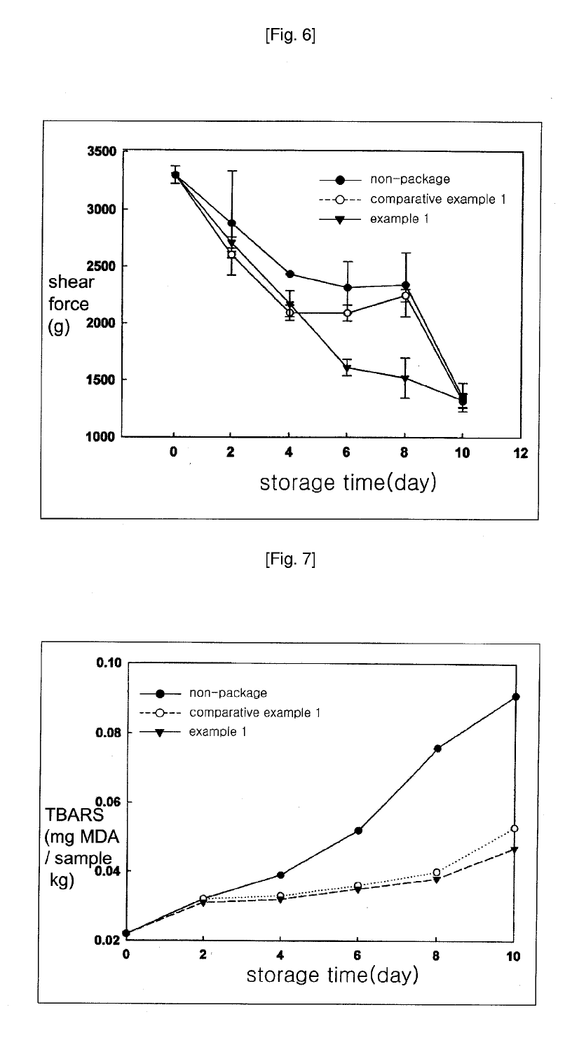

FIG. 6 is a graph showing the change in shear force over time when the food packaging film according to the present invention is used. As time passed, the sample meat become tender, decreasing shear force. After 6 to 8 days, the Example 1 sample showed the lowest shear force, which means good tenderness.

FIG. 7 is a graph showing the change in lipid oxidation (thiobarbiturate reactive substance: TBARS) over time when the food packaging film according to the present invention is used. The non-package group showed abrupt increase of TBARS after 4 days. The Comparative Example 1 sample and the Example 1 sample showed a little increase of TBARS after 8 days. The Example 1 sample showed better lipid oxidation inhibiting effect than the Comparative Example 1 sample.

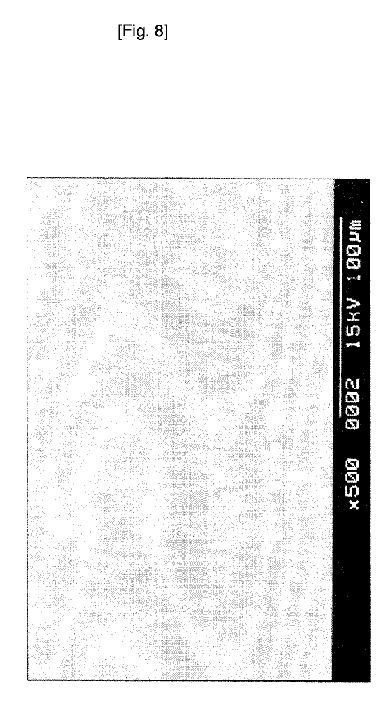

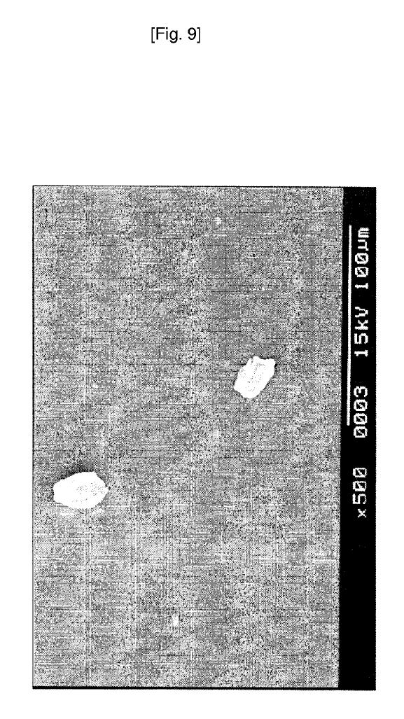

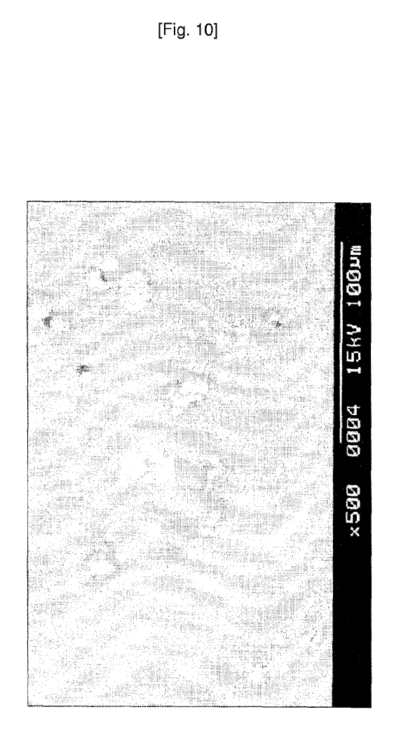

FIG. 8 is a SEM photograph showing a conventional packaging film, FIG. 9 is a SEM photograph showing the packaging film according to the present invention, and FIG. 10 is a SEM photograph showing the condition after chitosan has been removed from the packaging film of FIG. 9. It was shown that when water-containing food was packed, chitosan was released from the packaging film to form a plurality of pinholes in the film. Therefore, it was expected that the film according to the present invention could be decomposed more easily than the common film due to the pinholes formed by release of chitosan.

### MODE FOR INVENTION

Now, the present invention will be described in detail.

### Example 1 to 3 and Comparative Example 1 to 3

Films of Examples 1 to 3 and Comparative Examples 2 and 3 were prepared by using a screw for low density polyethylene having a dimension of 55 [symbol] as an extruder.

The method for extruding a film included charging commonly used materials and setting the extrusion conditions of a film width of 26 [symbol] and a film thickness of 22 [symbol] . After the material in the charging port was used up under the stable condition, each material of Examples and Comparative Examples was added to a hopper and observed for 2 to 3 minutes. Then, a film was extruded and 5 minutes later, a normal film was obtained. Here, the film was drawn for 300 m in twofold and an embossing roller was not used to examine the dispersion of chitosan.

Chitosan powder was prepared by adding chitosan having a molecular weight of 100,000 to an organic acid solution to form a chitosan solution at pH 6.0 and lyophilizing the solution for 24 hours.

### Example 1

2.0 g of a premix containing chitosan prepared by mixing 99.5 g of polyethylene film flaks and 0.5 g of chitosan powder was mixed with 98.0 g of polyethylene resin and added to an extruder for synthetic resin film to obtain a film.

### Example 2

A film was prepared by following the procedure of Example 1, except for using 8.0 g of the premix containing chitosan, prepared by mixing 90.0 g of polyethylene film flakes with 10.0 g of chitosan powder, and 92.0 g of polyethylene resin.

### Example 3

A film was prepared by following the procedure of Example 1, except for using 10.0 g of premix containing chitosan, prepared by mixing 80.0 g of polyethylene film flakes with 20.0 g of chitosan powder, and 92.0 g of polyethylene resin.

### Comparative Example 1

A common food packaging film was used.

### Comparative Example 2

A film was prepared by following the procedure of Example 1, except for using 1.0 g of chitosan powder and 99.0 g of polyethylene resin without polyethylene film flakes.

### Comparative Example 3

A film was prepared by following the procedure of Example 1, except for using 10.0 g of premix containing chitosan, prepared by mixing 99.6 g of polyethylene film flakes with 0.4 g of chitosan powder, and 98.0 g of polyethylene resin.

Each film prepared in Examples 1 to 3 and Comparative Examples 1 to 3 was examined for antibacterial activity and evaporation residue, and tensile strength and elongation as mechanical properties. The result is shown in Table 1.

TABLE 1

| | | Comparative | | | | | |
|---|---|---|---|---|---|---|---|
| | Example | Example | | | | | |
| 1 | 2 | 3 | 1 | 2 | 3 | | |
| Antibacterial | E. coli | 98.09 | 98.75 | 99.24 | — | 84.23 | 71.46 |
| activity | | | | | | | |
| (%) | | | | | | | |
| S. aureus | 97.69 | 98.71 | 99.37 | — | 83.51 | 69.82 | |
| Evaporation | 10.80 | 11.87 | 15.95 | 1.05 | 7.28 | 6.27 | |
| residue | | | | | | | |
| (□/L) | | | | | | | |
| Tensile | Width | 318.1 | 315.6 | 314.8 | 321.5 | 311.2 | 312.0 |
| strength | | [3,117.4] | [3,092.9] | [3,085.0] | [3,150.7] | [3,049.8] | [3,057.6] |
| (□f/□) | | | | | | | |
| [N/□] | | | | | | | |
| Length | 384.0 | 383.7 | 383.1 | 459.1 | 404.8 | 423.6 | |
| | [3,763.2] | [3,760.3] | [3,754.4] | [4,499.2] | [3,967.0] | [4,151.3] | |
| Elongation | Width | 1,106 | 1,103 | 1,101 | 1,122 | 1,082 | 1,093 |
| (%) | | | | | | | |
| Length | 502 | 498 | 495 | 516 | 488 | 495 | |

(Measurement)

Each film prepared by the compositions of Examples and Comparative Examples was cut into a specimen of 10 cm×10 cm under the same condition and dipped in 4% acetic acid solution for 24 hours. Then, the film was removed and the solution where the film had been dipped was examined for antibacterial activity and evaporation residue.

1) Antibacterial activity: E. coli and S. aurenus were cultured for 24 hours and the produced colonies were counted to calculate the antibacterial activity.
Antibacterial activity (%)=(the number of the control colony−the number of the treatment colony)/the number of the control colony×100

2) Evaporation residue: The acetic acid solution for dipping was dried to obtain residue, which was then examined.

3) Tensile strength: KS M3001
Tensile strength (N/ [symbol] )=(maximum load upon breakage)(N)/(thickness of specimen ( [symbol] )×width of specimen ( [symbol] ))

4) Elongation: KS M3001
Elongation (%)=(distance between points upon breakage( [symbol] )-distance between points( [symbol] ))/(distance between points( [symbol] ))×100

As can be seen from Table 1, Examples 1 to 3, in which the chitosan-containing premix comprising polyethylene film flakes and chitosan powder was used in the foregoing content range so that chitosan was evenly dispersed in the film showed excellent antibacterial activity and produced more evaporation residue, as compared to Comparative Examples. Comparative Example 1 which was a common film without containing chitosan did not show antibacterial effect and produced little evaporation residue. Comparative Example 2 which did not contain polyethylene film flakes in the premix containing chitosan showed poor antibacterial activity since chitosan powder was not evenly dispersed throughout the film and the evaporation residue was small, as compared to Examples. Comparative Example 3, in which polyethylene film flakes were used in an amount exceeding the specified range and the chitosan powder content is insufficient, showed poor antibacterial activity and reduction in the evaporation residue.

Also, tensile strength and elongation of Examples 1 to 3 did not show any significant difference from those of Comparative Example 1 which was a common food packaging film without containing chitosan. Therefore, it was proved that the properties of the packaging film were maintained without deterioration in properties of the packaging film.

### INDUSTRIAL APPLICABILITY

The present invention relates to a method for preparing a food packaging film containing chitosan, and more particularly, it relates to a method for preparing a food packaging film using a premix containing chitosan powder, in which the chitosan powder particles are evenly dispersed and distributed in the food packaging film so that they can be slowly released to prevent deterioration of the food by microorganisms upon a long term storage, while suppressing oxidation and maintaining peculiar taste and color of the food for fresh storage.

1. A method for preparing a chitosan-containing film for food packaging comprising the steps of: [symbol]
) adding chitosan powder having a molecular weight of 30,000 to 500,000 to an organic acid solution to a pH of 3.0 to 6.0 to form a chitosan solution and lyophilizing the solution for 24 to 72 hours, followed by pulverization to form fine powder; [symbol]
) mixing 80.0 to 99.5% by weight of fine flakes of polyethylene film, separately prepared, with 0.5 to 20.0% by weight of the chitosan powder, prepared in the step [symbol] ) to form a premix containing chitosan; and [symbol]
) extruding 2.0 to 10.0% by weight of the premix containing chitosan, prepared in the step ii), together with 90.0 to 98.0% by weight of polyethylene resin.

2. The method according to claim 1, in which, when the chitosan powder in the step
i) comprises a low molecular weight molecule and oligosaccharide having a molecular weight of less than 30,000, the chitosan powder is used as it is without dissolution in the organic acid.

3. The method according to claim 1, in which the polyethylene film flakes is prepared by finely cutting a polyethylene film having a thickness of 5 to 70 [symbol] to a size of 0.5 to 5 [symbol] .

4. The method according to claim 1, in which the chitosan powder has a particle size of 4 to 50 [symbol] .
